(19) United States
(12) Patent Application Publication
(10) Pub. No.: US 2018/0302843 A1
(43) Pub. Date: Oct. 18, 2018

(54) Wireless Communication Device and Method for Managing System Information Provided by a Wireless Communication Network

(71) Applicant: Telefonaktiebolaget LM Ericsson (publ), Stockholm (SE)

(72) Inventors: Pål Frenger, Linköping (SE); Martin Hessler, Linköping (SE); Niclas Wiberg, Linköping (SE)

(21) Appl. No.: 15/524,177

(22) PCT Filed: Mar. 31, 2017
(86) PCT No.: PCT/SE2017/050319

§ 371 Date: May 3, 2017

(51) Int. Cl. H04W 48/10

(52) U.S. Cl. CPC H04W 48/10

(57) ABSTRACT

A method and wireless communication device (120) for managing system information provided by a wireless communication network (100) that the wireless communication device (120) is configured to operate with. The wireless communication device (120) receives (801; 901) a broadcasted first part of system information from the wireless communication network (100). The wireless communication device (120) then obtains (802; 902) a further, second part of system information based on which of at least two different information formats that is used in the first part.

### TECHNICAL FIELD

Embodiments herein concern a wireless communication device and a method for managing system information provided by a wireless communication network, e.g. a telecommunication network.

### BACKGROUND

Communication devices such as wireless communication devices, that simply may be named wireless devices, may also be known as e.g. User Equipments (UEs), mobile terminals, wireless terminals and/or Mobile Stations (MS). A wireless device is enabled to communicate wirelessly in a wireless communication network, e.g. a cellular communications network, which may also be referred to as a wireless communication system, or radio communication system, sometimes also referred to as a cellular radio system, cellular network or cellular communication system. A wireless communication network may sometimes simply be referred to as a network and abbreviated NW. The communication may be performed e.g. between two wireless devices, between a wireless device and a regular telephone and/or between a wireless device and a server via a Radio Access Network (RAN) and possibly one or more Core Networks (CN), comprised within the wireless communication network. The wireless device may further be referred to as a mobile telephone, cellular telephone, laptop, Personal Digital Assistant (PDA), tablet computer, just to mention some further examples. Wireless devices may be so called Machine to Machine (M2M) devices or Machine Type Communication (MTC) devices, i.e. a device that is not necessarily associated with a conventional user, such as a human, directly using the device. MTC devices may be as defined by the 3rd Generation Partnership Project (3GPP).

The wireless device may be, for example, portable, pocket-storable, hand-held, computer-comprised, or vehicle-mounted mobile device, enabled to communicate voice and/or data, via the RAN, with another entity, such as another wireless device or a server.

The wireless communication network covers a geographical area which conventionally is divided into cell areas, wherein each cell area is served by at least one base station, or Base Station (BS), e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby e.g. also on cell size. A cell is typically identified by one or more cell identities. The base station at a base station site provides radio coverage associated with one or more cells and/or beams. Beams are further discussed below. A cell and beam may thus be associated with geographical areas, respectively, where radio coverage for the cell and beam, respectively, is provided by a base station at a base station site. Cells and/or beams may overlap so that several cells and/or beams cover the same geographical area. By a base station providing or serving a cell and/or beam is meant that the base station provides radio coverage such that one or more wireless devices located in the geographical area where the radio coverage is provided may be served by the base station in said cell and/or beam. When a wireless device is said to be served in or by a cell and/or beam this implies that the wireless device is served by the base station providing radio coverage for the cell and/or beam. One base station may serve one or several cells and/or beams. Further, each base station may support one or several communication technologies. The base stations communicate over the air interface operating on radio frequencies with the wireless device within range of the base stations.

The expression downlink, which may be abbreviated DL, is used for the transmission path from the wireless communication network, e.g. a base station thereof, to the wireless device. The expression uplink, which may be abbreviated UL, is used for the transmission path in the opposite direction i.e. from the wireless device to the wireless communication network, e.g. base station thereof.

In some RANs, several base stations may be connected, e.g. by landlines or microwave, to a radio network controller, e.g. a Radio Network Controller (RNC) in Universal Mobile Telecommunication System (UMTS), and/or to each other. The radio network controller, also sometimes termed a Base Station Controller (BSC) e.g. in GSM, may supervise and coordinate various activities of the plural base stations connected thereto. GSM is an abbreviation for Global System for Mobile Communication (originally: Groupe Spécial Mobile).

In 3GPP Long Term Evolution (LTE), base stations, which may be referred to as eNodeBs or eNBs, may be directly connected to other base stations and may be directly connected to one or more core networks.

UMTS is a third generation mobile communication system, which may be referred to as 3rd generation or 3G, and which evolved from the GSM, and provides improved mobile communication services based on Wideband Code Division Multiple Access (WCDMA) access technology. UMTS Terrestrial Radio Access Network (UTRAN) is essentially a radio access network using wideband code division multiple access for wireless devices.

General Packet Radio Service (GPRS) is a packet oriented mobile data service on the 2G cellular communication system's global system for mobile communications (GSM).

Enhanced Data rates for GSM Evolution (EDGE) also known as Enhanced GPRS (EGPRS), or IMT Single Carrier (IMT-SC), or Enhanced Data rates for Global Evolution is a digital mobile phone technology that allows improved data transmission rates as a backward-compatible extension of GSM.

High Speed Packet Access (HSPA) is an amalgamation of two mobile telephony protocols, High Speed Downlink Packet Access (HSDPA) and High Speed Uplink Packet Access (HSUPA), defined by 3GPP, that extends and improves the performance of existing 3rd generation mobile telecommunication networks utilizing the WCDMA. Such networks may be named WCDMA/HSPA.

The 3GPP has undertaken to evolve further the UTRAN and GSM based radio access network technologies, for example into evolved UTRAN (E-UTRAN) used in LTE.

Work is ongoing with developing a next generation wide area networks, which may be referred to as NeXt generation (NX), New Radio (NR), fifth generation (5G), or 5G NR. A design principle under consideration for 5G wireless communication networks is to base it on an ultra-lean design. This implies that “always on signals”, such as reference signals in LTE, shall be avoided in the network as much as possible. Expected benefits from this design principle include e.g. significantly lower network energy consumption, better scalability, higher degree of forward compatibility, lower interference from system overhead signals and consequently higher throughput in low load scenario, and also improved support for wireless device, or so called user, centric beam-forming.

Advanced Antenna Systems (AAS) is an area where technology has advanced significantly in recent years and where we also foresee a rapid technology development in the years to come. Advanced antenna systems in general and massive Multiple Input Multiple Output (MIMO) transmission and reception will likely be used in future wireless communication network and in 5G wireless communication networks.

A beam, such as mentioned above, is traditionally associated with transmission using so called beamforming, typically by means of a phase-adjustable, or phased, antenna array, the same underlying technique is equally applicable to reception. Beamforming, or spatial filtering, may be described as a signal processing technique for directional signal transmission and/or reception. This is typically achieved by combining elements in the phased antenna array, often referred to simply as a phased array, in such a way that signals at particular angles experience constructive interference while others experience destructive interference. Beamforming can be used at both the transmitting and receiving ends in order to achieve spatial selectivity. Thereby, thanks to directivity, improvements are possible to achieve compared with omnidirectional reception/transmission.

A beam provided by a network node is typically for communication with, e.g. for serving, one or a few (compared to a conventional cell) communication devices at the same time, and may be specifically set up for communication with these. The beam may be changed dynamically by beamforming to provide desirable coverage for the one or few communication devices communicating using, e.g. being served by, the beam. A beam provided by a communication device is typically for communication with the wireless communication network, particularly one or a few radio network nodes thereof, typically one, or at least one, that is a main target for the beam.

For NR an index-based system information, i.e. SI, distribution concept is considered.

FIG. 1 schematically depicts an overview of a potential solution for NR system information distribution, corresponding to proposed system information acquisition for NR. In NR a first part of what may be named minimum system information is provided in a Synchronization Signal (SS) Block. A SS Block comprises a Primary Synchronization Signal and/or Secondary Synchronization Signal for NR (NR-PSS/SSS), which defines the Physical Cell Identity (PCI). The SS Block may also comprise a Tertiary Synchronization Signal (TSS) for NE (NR-TSS) that provides time information that is not included in a Master Information Block for NR (NR-MIB), e.g. a SS Block index in a SS Burst Set. The NR-MIB is transmitted together with the NR-PSS/NR-SSS inside a Physical Broadcast Channel for NR (NR-PBCH). The PCI defines the NR cell. In case a cell transmits the synchronization signals in different beams during different time slots then the NR-MIB content may be different in different beams.

The NR-MIB contains information on how the UE can receive a first System Information Block for NR (NR-SIB1) which is transmitted in a Physical Downlink Shared CHannel for NR (NR-PDSCH) and possibly on a Physical Downlink Control CHannel (NR-PDCCH) that schedules the NR-PDSCH. Typically, the NR-PDSCH contains all the remaining minimum system information in the NR-SIB1. Hence, what may be referred to as minimum SI is in NR contained in the SS Block and the NR-SIB1. In case of “other SI”, i.e. not part of the broadcasted minimum SI, this must be requested and be sent on demand. The NR-SIB1 will then contain the necessary configurations the UE need for this.

By transmitting NR-SIB1 in a physical channel configured in the NR-MIB it is enabled that multiple cells and beams may cooperate in transmitting the essential SIBs, e.g. using Single Frequency Network (SFN) modulation.

The prefix “NR-” before some signals and channels may be used to distinguish from corresponding signals and channels used in LTE that conventionally use no prefix, although LTE may apply the prefix “LTE-” in a corresponding manner.

The following may be assumed for distribution of what may be called minimum SI in NR:
The PCI and the NR-MIB is transmitted in an SS Block (NR-PSS+NR-SSS+NR-TSS+NR-PBCH) with a period of e.g. 20 ms.
At least the NR-SIB1 is transmitted in a second physical channel (NR-PDCCH/NR-PDSCH) that is configured in the NR-MIB. NR-SIB1 contains information about how the other SIBs are transmitted.

The name “minimum SI” may refer to SI at least required to be able to make a system access. As already indicated above, this information is provided in the SS Block, comprising the NR-MIB, and in the NR-SIB1.

By separating the minimum SI in two parts, e.g. the NR-MIB in NR-PBCH and NR-SIB1 in NR-PDCCH/NR-PDSCH, it is enabled efficient SI distribution in scenarios relevant for NR.

FIG. 2 schematically illustrates an example situation with joint transmissions of SIBs in a multi-cell scenario. FIG. 2 depicts how the minimum SI could be transmitted in a multi-cell scenario, e.g. a Centralized Radio Access Network (C-RAN) deployment. Each node in this scenario transmits separate PCIs and NR-MlBs. The PCIs are different and defines the two cells in this example. Each cell transmits one NR-MIB each in an omni-beam together with the PCI. In addition, each of the gNBs jointly transmit the NR-SIB1 in a second periodic transmission on NR-PDCCH/NR-PDSCH, using a Single-Frequency Network (SFN) transmission format. The periodically broadcasted NR-SIB1 comprises parameters for more than one PCI in one and the same SI message. In this example the configurations may differ, e.g. in which Physical Random Access CHhannel (PRACH) pre-ambles that are defined for accessing the cell.

FIG. 3 schematically depicts an example of joint transmissions of NR-SIB1 in a multi-beam scenario. In the shown example there is one cell defined by PCI1 consisting of 8 beams. In this example each set of two nearby beams use the same NR-MIB. By allowing for different NR-MIBs in different beams there can be different PRACH parameters, e.g. PRACH pre-ambles and PRACH timing window, in different beams. By also allowing for some beams, e.g. the adjacent pair of beams in the example, to transmit identical NR-MIBs it can be defined a smaller number of PRACH timing windows than the number of beams defined in the downlink.

Since the NR-SIB1 in NR-PDCCH/NR-PDSCH may be relevant for multiple beams, such as shown in FIG. 3, as well as for a node with different PCI, as shown in FIG. 2, it is in this case not sufficient to only have one system information value tag transmitted in the NR-MIB. Therefore, in addition to the system information value tag, a system information index, or SI index, has been introduced to distinguish which configuration to use in each beam or cell in case the NR-SIB1 contains system information relevant for more than one beam or cell.

FIG. 4 schematically depicts an example of a proposed structure regarding system information. The PCI is signalled by the index of NR-PSS/NR-SSS, a NR-MIB is signalled in a first broadcast channel denoted NR-PBCH, and periodically broadcasted NR-SIB1 is signalled in a second channel denoted NR-PDCCH/NR-PDSCH.

In FIG. 4 there is also shown some additional details related to what has been discussed regarding minimum SI. The SS Block provides the PCI and the NR-MIB. The NR-MIB contains a system information value tag here named ValueTag, a System Frame Number (SFN) field, and a configuration, here named NR-SIB1_Config, enabling the UE to receive the NR-SIB1. The value tag may be interpreted as determining which configuration in NR-SIB1, or other NR-SIB(s), that shall apply to each beam or cell. This enables different beams to use different PRACH time slots or different PRACH pre-amble sequences for example.

In the example of FIG. 3 the NR-TSS may be used to enable different beams to use different SI without requiring that each beam transmit that SI explicitly. As beams become many and narrow a UE will stay for a short time in each beam before entering a new beam belonging to the same cell. When that happens, the UE should quickly acquire the SI associated to this new beam. If the UE already has a stored copy of that SI it may immediately use that. An alternative would be that each beam transmits its own SI with a high periodicity which would be much more expensive and require much energy more signalling compared to only transmitting an SS Block.

### SUMMARY

In view of the above, an object is to provide one or more improvements with regard to how system information is managed in a wireless communication network.

According to a first aspect of embodiments herein, the object is achieved by a method, performed by a wireless communication device, for managing system information provided by a wireless communication network that the wireless communication device is configured to operate with. The wireless communication device receives a broadcasted first part of system information from the wireless communication network. The wireless communication device then obtains a further, second part of system information based on which of at least two different information formats that is used in the first part.

According to a second aspect of embodiments herein, the object is achieved by a computer program comprising instructions that when executed by a wireless communication device causes the wireless communication device to perform the method according to the first aspect.

According to a third aspect of embodiments herein, the object is achieved by a carrier comprising the computer program according to the second aspect.

According to a fourth aspect of embodiments herein, the object is achieved by a wireless communication device for managing system information provided by a wireless communication network that the wireless communication device is configured to operate with. The wireless communication device is further configured to receive a broadcasted first part of system information from the wireless communication network. Moreover, the wireless communication device is configured to obtain a further, second part of system information based on which of at least two different information formats that is used in the first part.

The first part of the system information, i.e. SI, may e.g. be a Master Information Block for NR (NR-MIB) as mentioned in the Background and the second part of the may correspond to one or more System Information Blocks for NR, e.g. NR-SIB1, as also mentioned in the Background. There may thus be one of two, or one of at least two, different information formats in the first part of SI, e.g. in the NR-MIB. A first information format may be specific for the second part in the form of “on demand SIB(s)” and a second information format may be specific for the second part in the form of “periodically broadcasted SIB(s)”. The wireless communication device obtaining the second part based on which information format is being used in the first part thus means that at least two different information formats should be supported in the first part of SI, e.g. the NR-MIB, but only one need and should be used at the same time in the NR-MIB by the wireless communication network. For example, when it is desirable to switch to delivering SI “on-demand” instead of by “periodically broadcasted SI”, the information format of the first part, e.g. of the NR-MIB, can be changed from the second information format to the first information format. There is thus no need to share limited bits between multiple information formats, each information format may use all available bits, or the amount needed of available bits. This enables to keep down the number bits of the first part of the SI, e.g. the NR-MIB, while still supporting multiple ways of providing SI. Also, there may be only a limited, e.g. predetermined and/or fixed, number of bits available in the first part, e.g. the NR-MIB, to provide required information enabling to obtain “on-demand SIBs” or to provide required information enabling to obtain “periodically broadcasted SIBs”. The limited number of bits may not be sufficient for both of said required information.

Embodiments herein thus enables a compact first part of SI, e.g. NR-MIB, containing a comparatively small number of bits to be transmitted even though different ways of providing SI is still supported. Embodiments herein enables a flexible solution and enhances the usefulness and the coverage of the NR-MIB, enables reduction of interference and network energy consumption. With a small NR-MIB it is also facilitated to send it in several beams, e.g. using beam-sweeping, without that the cost of transmitting the NR-MIB becomes prohibiting.

Hence, embodiments herein provide one or more improvements with regard to how system information is managed in a wireless communication network.

### BRIEF DESCRIPTION OF THE DRAWINGS

Examples of embodiments herein are described in more detail with reference to the appended schematic drawings, which are briefly described in the following.

FIG. 1 schematically depicts an overview of a potential solution for NR system information distribution.

FIG. 2 schematically illustrates an example situation with joint transmissions of SIBs in a multi-cell scenario.

FIG. 3 schematically depicts an example of joint transmissions of SIB1 in a multi-beam scenario.

FIG. 4 schematically depicts an example of a proposed structure regarding system information.

FIG. 5 is a block diagram schematically depicting an example of a wireless communication network relevant for embodiments herein.

FIGS. 6a-b schematically depicts an example based on some embodiments herein.

FIG. 7 is a flow chart schematically depicting an example procedure for accessing a network based on some embodiments herein.

FIG. 8 is a combined signaling diagram and flowchart for describing some embodiments herein in an exemplary scenario.

FIG. 9 is a flowchart schematically illustrating embodiments of a method according to embodiments herein.

FIG. 10 is a functional block diagram for illustrating embodiments of a wireless communication device according to embodiments herein and how it can be configured to carry out the first method.

FIGS. 11a-c are schematic drawings illustrating embodiments relating to computer program products and computer programs to cause the wireless communication device to perform the method.

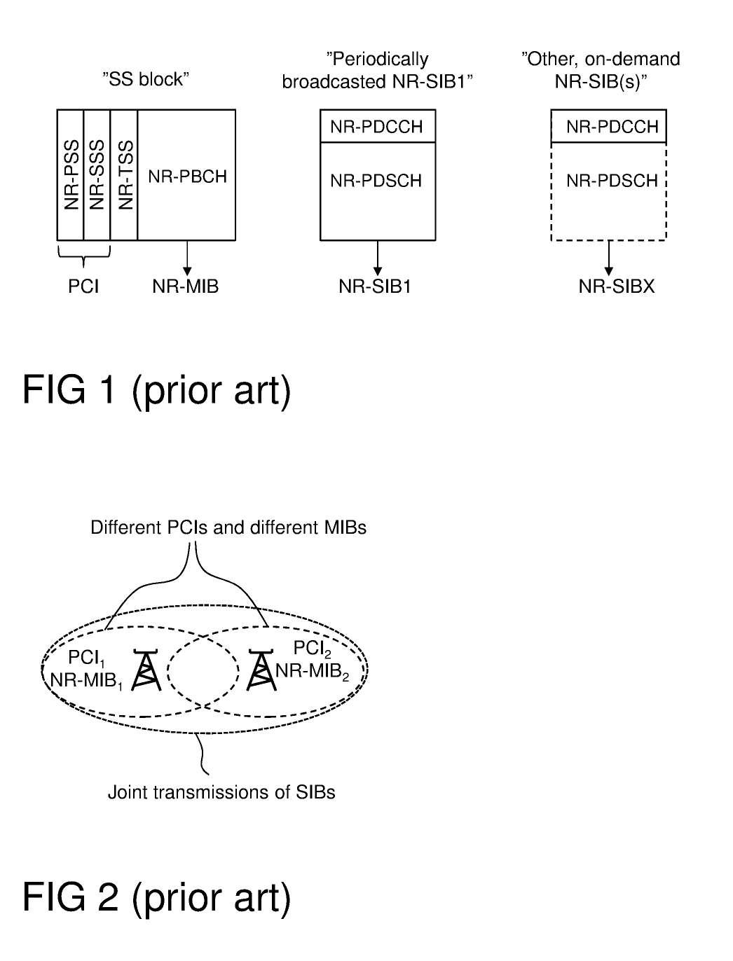

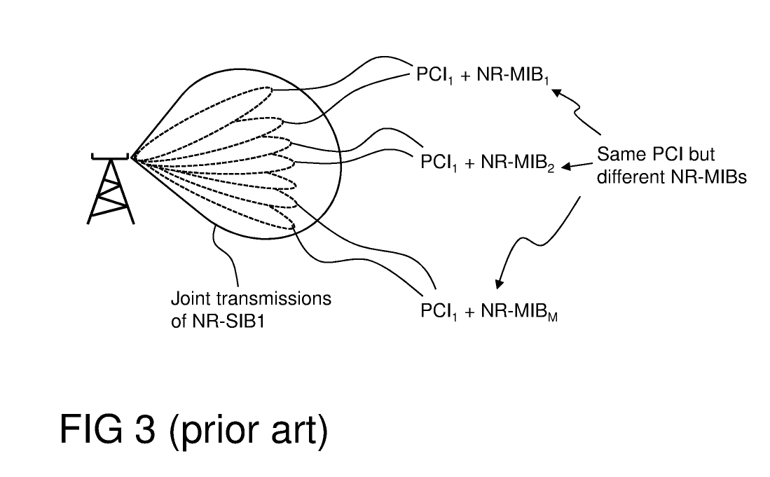

### DETAILED DESCRIPTION

Throughout the following description similar reference numerals may be used to denote similar elements, units, modules, circuits, nodes, parts, items or features, when applicable. Features that appear only in some embodiments of what is shown in a figure, are typically indicated by dashed lines in the drawings.

In the following, embodiments herein are illustrated by exemplary embodiments. It should be noted that these embodiments are not necessary mutually exclusive. Components from one embodiment may be tacitly assumed to be present in another embodiment and it will be obvious to a person skilled in the art how those components may be used in the other exemplary embodiments.

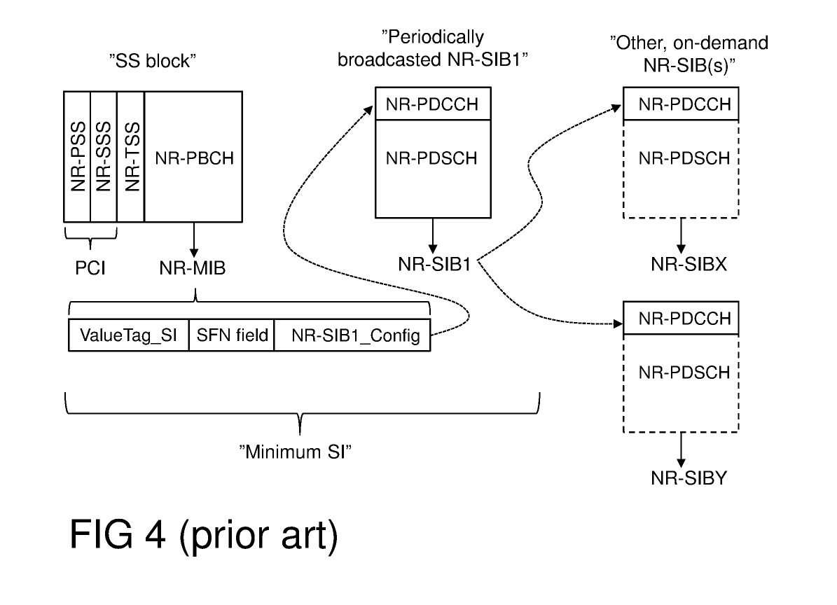

Each of the two solutions, i.e. “periodically broadcasted SIB(s)” and “on-demand SIB(s)”, on how to provide system information that have been discussed for NR in the prior art, and as indicated in the Background, has pros and cons. It has therefore been realized that it may be desirable to support both solutions and preferably already from the beginning when NR networks are deployed. If a NR network and UEs to begin with would support only one of the solutions, e.g. the “periodically broadcasted SIBs” solution that may facilitate initial deployment, it may become difficult to later introduce the other “on-demand” solution since it requires updates on network equipment and UEs already operative and in use. Many UEs may further be MTC devices and not easily accessible for updates. However, if both solutions are implemented simultaneously and in a manner similar as indicated in FIG. 4, the signalling would become comparatively extensive, and it may be difficult to be able to acquire SI as fast as wold be desirable.

Further, in the prior art solutions shown in FIG. 4, the NR-MIB contains a configuration of a second physical channel. However, in case SI is provided “on demand”, then this configuration is actually not needed. Transmitting a configuration of a physical channel that only contains information regarding that the system information can be requested “on demand” is a waste of bits in the NR-MIB. Hence, if only the “on demand” solution is implemented, information related to “on demand” SI can be located directly in the NR-MIB. However, this would mean that the other “periodically broadcasted SIBs”, solution would not be supported at all. Information regarding both solutions could be transmitted simultaneously in the NR-MIB but the amount of bits required would then be greater than desirable per NR-MIB, or even be greater than what is possible to transmit per MIB as frequent as would be desirable since there may be a limited and fixed number of bits available for SI in the NR-MIB, e.g. in order to be able to meet other requirements. Also, if information regarding both solutions are in the NR-MIB simultaneously, this would mean that there would be information redundancy, which is not energy efficient.

To overcome the above and provide a solution directed to solve the indicated issues, embodiments herein are instead based on that at least two different information formats are supported in the NR-MIB regarding SI, one per solution. It will be up to UEs to identify which information format is being used, interpret the information accordingly and then act using this information to access the rest of the SI. The format of the NR-MIB, or format being used in the NR-MIB, may thus depend on if the system information, i.e. SI, e.g. so called minimum SI, required to access the system, i.e. a wireless communication network such as a NR network, is periodically broadcasted, or if it is transmitted “on demand”. That is, at least two different information formats should be supported in the NR-MIB, but only one at a time. In view of the problems discussed above this would clearly improve how SI is managed.

Hence, when it is e.g. desirable to switch to delivering SI “on-demand”, the format of the NR-MIB can be changed from a format associated with periodically broadcasted SI. This enables a very compact NR-MIB containing a very small number of bits.

Embodiments herein thus enhance the usefulness and the coverage of the NR-MIB, reduces interference, and reduces the network energy consumption. With a small NR-MIB it is facilitated to send it in several beams, e.g. using beam-sweeping, without the cost of transmitting the NR-MIB becoming prohibiting.

The following is a first example according to some embodiments herein:

A method in a wireless communication device for system access, e.g. for accessing a wireless communication network, comprising:
1. Receiving a, e.g. SS block, defining at least a start position candidate of a Physical Broadcast CHannel (NR-PBCH), e.g. NR-PBCH with a NR-MIB.
2. Determining a format associated with said NR-PBCH, e.g. of the NR-MIB, which determination may be based on one or more of the following:
   an index associated with said synchronization signal, e.g. odd and/or even,
   a certain field, e.g. format field, transmitted on said NR-PBCH, and
   blind decoding attempts of said NR-PBCH and/or NR-MIB, such as based on one or more of the following:
      assuming format dependent scrambling code,
      format dependent Cyclic Redundancy Check (CRC),
      format dependent physical resources, e.g. different start and/or stop positions of said NR-PBCH,
   a format dependent demodulation reference signal.
3. Obtaining, based on the determined format, either
   a configuration of a channel used for periodic broadcast of system information, or
   a configuration for how to request an on-demand transmission of system information and how to receive a requested on-demand transmission of system information.
4. Receiving system information in accordance with the obtained configuration.
5. Accessing the wireless communication network based on, e.g. in accordance with said, received system information.

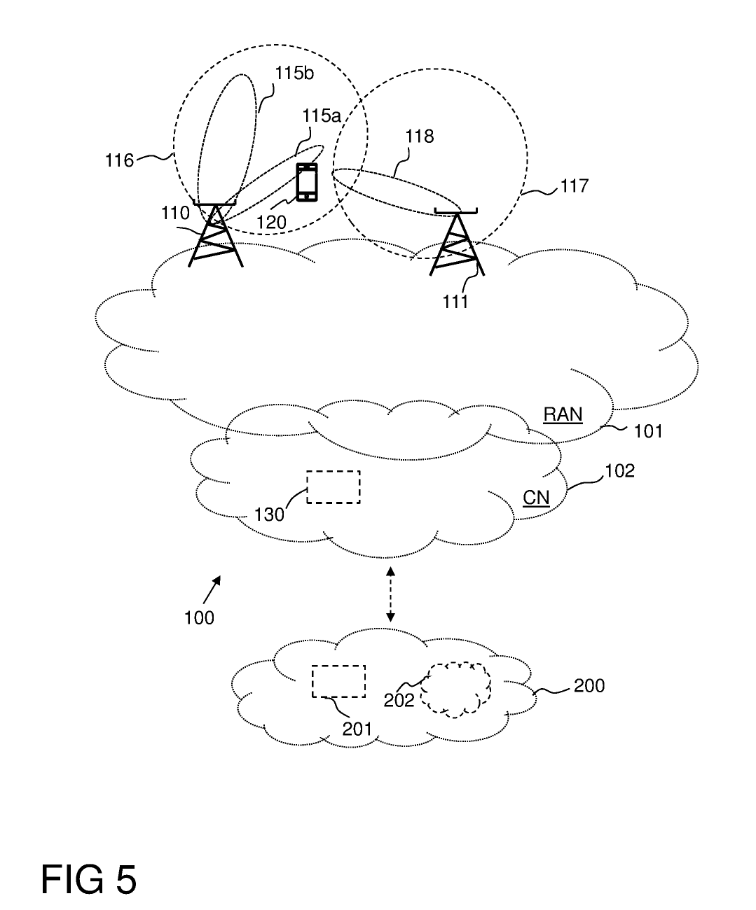

FIG. 5 is a schematic block diagram schematically depicting an example of a wireless communication network 100 that may be relevant for embodiments herein and in which embodiments herein may be implemented. The wireless communication network 100 may comprise a Radio Access Network (RAN) 101 part and a core network (CN) 102 part. The wireless communication network 100 is typically a telecommunication network or system, such as a cellular communication network that supports at least one Radio Access Technology (RAT), e.g. NR, and that may be based on a so called “lean design”, where “always on” signaling is not used or present, or at least desirable to keep to a minimum.

The wireless communication network 100 comprises network nodes that are communicatively interconnected. The network nodes may be logical and/or physical and are located in one or more physical devices. The wireless communication network 100 comprises one or more network nodes, e.g. a first radio network node 110, and/or a second radio network node 111 may be comprised in the RAN 101. A radio network node typically comprises a radio transmitting network node, such as base station, and/or that is or comprises a controlling node that control one or more radio transmitting network nodes. The first and second radio network nodes may be named eNBs in case of LTE or gNBs in case of NR 5G.

The wireless communication network 100, or specifically one or more network nodes thereof, e.g. the radio first network node 110 and the second radio network node 111, is configured to serve and/or control and/or manage one or more wireless communication devices, such as a wireless communication device 120, in one or more cells and/or using one or more beams provided by the wireless communication network 100, e.g. the first radio network node 110 and/or the second radio network node 111. As should be recognized by the skilled person, a so called beam is a more dynamic and relatively narrow and directional radio coverage compared to a conventional cell, and is typically accomplished by so called beamforming. A beam is typically for serving one or a few communication devices at the same time, and may be specifically set up for serving this one or few communication devices. The beam may be changed dynamically by beamforming to provide desirable coverage for the one or more communication devices being served by the beam. For example, the first radio network node 110 may provide a first cell 116, a first beam 115a and a second beam 115b for serving wireless communication devices. Correspondingly the second radio network node 111 may provide a second cell 117 and a third beam 118. The wireless communication device 120 may be positioned, as illustrated in the figure, so that it can access the wireless communication network via the first cell 116 and/or the first beam 115a.

It should be noted that there may be more than one cell and beam provided by each radio network node.

Moreover, the wireless communication network 100, such as the CN 102, may comprise one or more core network nodes of one or more different types, e.g. a core network node 130.

Moreover, the wireless communication network, e.g. the CN 102 and core network nodes thereof, may further be communicatively connected to, and thereby e.g. provide access for said wireless communication devices, to an external network 200, e.g. the Internet. A wireless device may thus communicate via the wireless communication network 100, with the external network 200, or rather with one or more other devices, e.g. servers and/or other communication devices connected to other wireless communication networks, and that are connected with access to the external network 200.

Moreover, there may be one or more external nodes, e.g. an external node 201, for communication with the wireless communication network 100 and node(s) thereof. The external node 201 may e.g. be an external management node. Such external node may be comprised in the external network 200 or may be separate from this.

Furthermore, the one or more external nodes may correspond to or be comprised in a so called computer, or computing, cloud, that also may be referred to as a cloud system of servers or computers, or simply be named a cloud, such as a computer cloud 202 as shown in the figure, for providing certain service(s) to outside the cloud via a communication interface. The exact configuration of nodes etc. comprised in the cloud in order to provide said service(s) may not be known outside the cloud. The name “cloud” is often explained as a metaphor relating to that the actual device(s) or network element(s) providing the services are typically invisible for a user of the provided service(s), such as if obscured by a cloud. The computer cloud 202, or typically rather one or more nodes thereof, may be communicatively connected to the wireless communication network 100, or certain nodes thereof, and may be providing one or more services that e.g. may provide, or facilitate, certain functions or functionality of the wireless communication network 100 and may e.g. be involved in performing one or more actions according to embodiments herein. The computer cloud 202 may be comprised in the external network 200 or may be separate from this.

Attention is drawn to that FIG. 5 is only schematic and for exemplifying purpose and that not everything shown in the figure may be required for all embodiments herein, as should be evident to the skilled person. Also, a wireless communication network or networks that in reality correspond(s) to the wireless communication network 100 will typically comprise several further network nodes, such as further and other type of core network nodes, e.g. base stations, radio network nodes, beams, and/or cells etc., as realized by the skilled person, but which are not shown herein for the sake of simplifying.

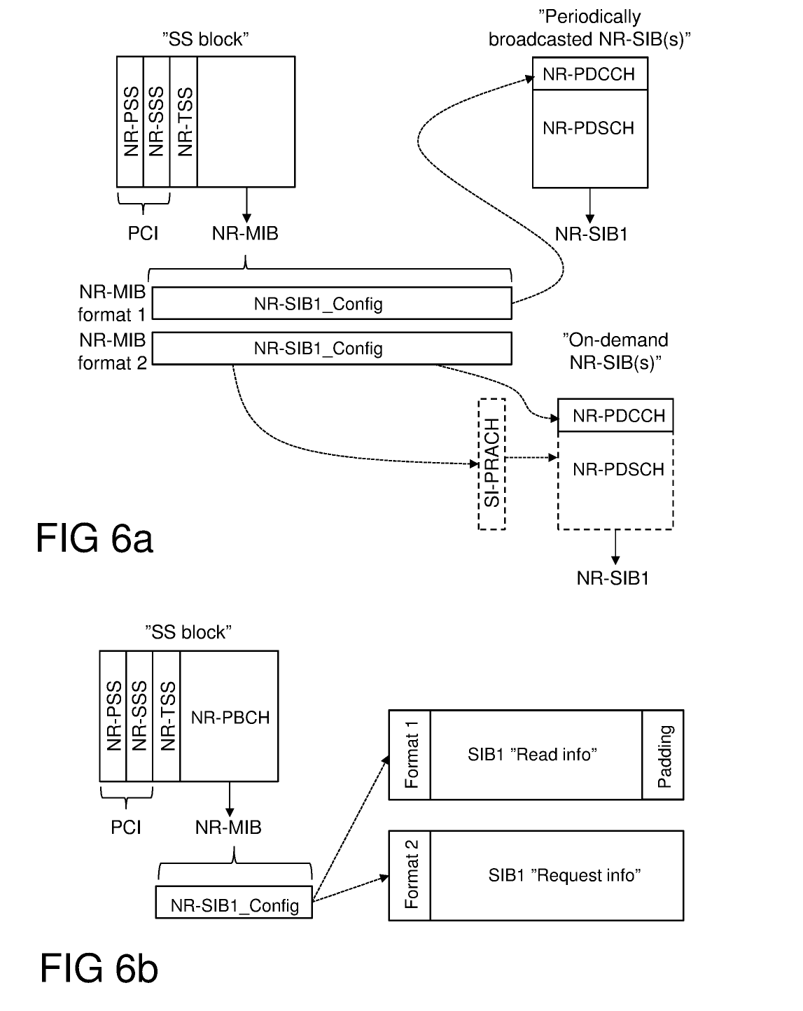

FIG. 6a schematically depicts a first example based on some embodiments herein and may be compared to the prior art and FIG. 4. As shown in FIG. 6a there are at least two versions of the NR-MIB with different formats, denoted NR-MIB format 1 and NR-MIB format 2 in the figure. Note that the NR-MIB may also contain other parameters not shown in the figure.

In case minimum system information that a UE, e.g. the wireless communication device 120, need in order to access the network, e.g. the wireless communication network 100, is periodically broadcasted, e.g. in the first cell 116 and/or the first beam 115a, then the NR-PBCH contains a NR-MIB of format 1. The NR-MIB in this case thus points to a second physical channel NR-PDCCH/NR-PDSCH and the rest of the minimum SI is broadcasted in the NR-PDCCH/NR-PDSCH in e.g. NR-SIB1, and may in this case thus may be referred to as “periodically broadcasted NR-SIB(s)”.

In case the minimum system information that the wireless communication device 120 need in order to access the wireless communication network 100, is not periodically broadcasted, but instead is to be requested and transmitted “on demand”, then the NR-PBCH channel contains a NR-MIB of format 2. The NR-MIB of format 2 contains information, such as a configuration, required to request on-demand system information, e.g. specifying a pre-amble, a timing window, and/or parameters for open-loop power control, as well as an identifier and/or configuration of the response channel that will be used to transmit the requested system information. The request may be made on a Physical Random Access CHannel for SI request (SI-PRACH). The identifier and/or configuration of the response channel may e.g. specify a NR-PDCCH and/or a NR-PDSCH where the SI will be transmitted, e.g. in NR-SIB1, and may in this case thus may be referred to as “on-demand NR-SIB(s)”.

FIG. 6b schematically depicts a more detailed example of how NR-MIB and the NR-SIB1_Config thereof in FIG. 6a may be structured in some embodiments. There may e.g. be a predetermined fixed number of bits allocated for the NR-SIB1_Config. Some, e.g. a single, of these bits may be predetermined to indicate the format, e.g. a format indicating bit being ‘0’ may indicate format 1 and ‘1’ may indicate format 2. If the UE, e.g. the wireless communication device 120, by the format indicating bit detects format 1, then it knows that the rest of the bits shall be interpreted according to format 1 and can obtain information on how to read the NR-SIB1, e.g. as a “periodically broadcasted NR-SIB1”. There may be some unused bits of the predetermined fixed number of bits allocated for the NR-SIB1_Config, which are named “padding” in the figure for this case. If the UE, e.g. the wireless communication device 120, by the format indicating bit instead detects format 1, then it knows that the rest of the bits shall be interpreted according to format 2 and can obtain information on how to request the NR-SIB1, i.e. as a “on-demand NR-SIB1”. In the shown example, all of the rest of the bits are used, i.e. no “padding” in this case.

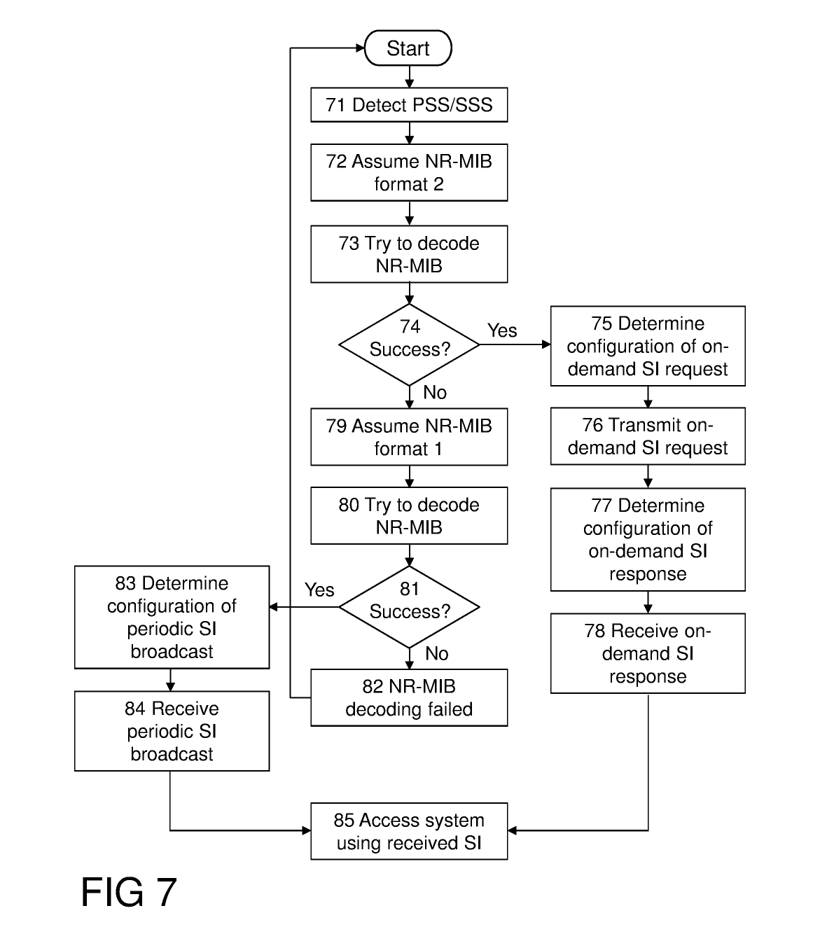

FIG. 7 is a flow chart schematically depicting an example procedure in a UE, e.g. the wireless communication device 120, for accessing a network, e.g. the wireless communication network 100, based on SI that is obtained in accordance with some embodiments herein and with reference to the situation shown in FIG. 6. The embodiments are here based on blind detection of the NR-MIB format.

In action 71 the wireless communication device 120 detects a synchronization signal, e.g. a primary and secondary synchronization signals denoted NR-PSS and NR-SSS, respectively, and thereby is able to and receives a NR-MIB.

In action 72 it is assumed that NR-MIB format 1 is used for the MIB, i.e. corresponding to a situation with “on demand SIBS”. In action 73 the wireless communication device 120 then tries to decode the NR-MIB using this assumption. If it succeeds according to action 74 it will thus in action 75 be able to determine a configuration of an “on demand” SI request, i.e. obtain information on how to request the SI “on demand” and or in other words obtain a configuration regarding how to request an SI transmission from the wireless communication network 100. The wireless communication device 120 then in action 76 transmits the on-demand SI request in accordance with the determined configuration, such as on the SI-PRACH. The wireless communication device 120 is also after the successful decoding able to in action 77 to determine a configuration of the on demand SI response, i.e. obtain information on how to receive the SI response to the transmitted SI request, or in other words how to receive the requested SI transmission. In action 78 the wireless communication device 120 receives the on-demand SI response in accordance with the determined configuration, such as SIBs on the NR-PDCCH and/or NR-PDSCH, and the wireless communication device 120 thereby has available SI, e.g. minimum SI, for a accessing the wireless communication network 100.

If there in action 74 is no success of decoding the NR-MIB according to NR-MIB format 1, it may instead in action 79 be assumed NR-MIB format 2. In action 80 the wireless communication device 120 then tries to decode the NR-MIB using this assumption. If there is no success with this according to action 81, the wireless communication device 120 may in action 82 conclude that the NR-MIB decoding failed and the wireless communication device 120 may start all over again with action 71. In some embodiments there may be more than two formats, then of course there may be further assumptions before restarting. If on the other hand, the wireless communication device 120 has success according to action 81 it will thus in action 83 be able to determine a configuration of a periodic SI broadcast, i.e. obtain information on where to find SI being broadcasted, or in other words obtain a configuration regarding where and how to find an SI broadcast being made by the wireless communication network 100. The wireless communication device 120 then in action 84 receive the SI broadcast in accordance with the determined configuration, such as receive NR-SIB1 from the NR-PDCCH/NR-PDSCH, and thereby the wireless communication device 120 has available SI, e.g. minimum SI, for a accessing the wireless communication network 100.

Hence, if at least one of the NR-MIB decoding attempt succeeds according to the assumptions on information format being used in the NR-MIB, the wireless communication device 120 will have available SI for accessing the wireless communication network 100. The wireless communication device 120 may thus in action 85 access the wireless communication network 100 using the SI.

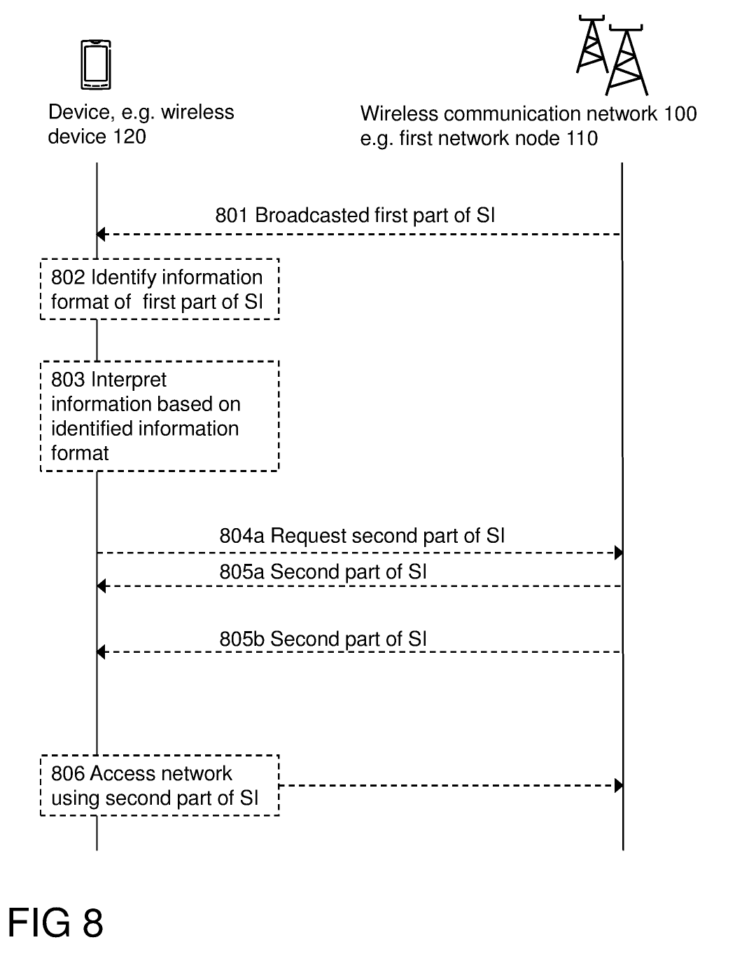

FIG. 8 depicts a combined signaling diagram and flowchart, which will be used to further discuss embodiments herein. The actions are for managing system information provided by a wireless communication network, e.g. the wireless communication network 100, that a wireless communication device, e.g. the wireless communication device 120, is configured to operate with.

The actions below may be taken in any suitable order and/or be carried out fully or partly overlapping in time when this is possible and suitable. Some actions are only present in some embodiments.

Action 801

The wireless communication network 100 broadcasts a first part of SI that the wireless communication device receives.

As used herein and as should be recognized by the skilled person, system information, or SI, in a wireless communication network, e.g. the wireless communication network 100, relevant for embodiments herein, such as a LTE or NR 5G network, refers to information, such as parameters, enabling a wireless communication device, e.g. the wireless communication device 100, to access the network, including e.g. how to find one or more cells and/or beams, here e.g. the first cell 115 and/or the first beam 115a, that provide such access. The SI thereby enables the wireless communication device to operate in the network using said one or more cells and/or beams.

This action may fully or partly correspond to action 71 above and receipt of the MIB.

Action 802

The wireless communication device 120 identifies which of at least two different information formats is being used in the received first part of SI. The identified information format enables the wireless communication device 120 to obtain a further, second part of system information based on which of said at least two different information formats that is used in the first part. The second part may e.g. be obtained based on which of said at least two different information formats that is comprised in predetermined bits in the broadcasted first part. For example, there may be a predetermined and/or fixed number of bits available that may be used to provide information according to the first format or to provide information according to the second format.

In some embodiments, a first information format of said at least two different information formats is a format provide to contain information that enables the wireless communication device 120 to request, and in response to the request receive, a further, second part.

In some embodiments, a second information format of said at least two different information formats is a format provided to contain information that specify where the wireless communication device 120 can receive said second part.

As used herein and as should be recognized by the skilled person, at least from the context herein, an information format is a format specifying how information is to be arranged and meaning thereof. If information, e.g. a bit sequence, is received and the information format of the information is known, it is possible to interpret the information correctly, i.e. according to the information format, else the information will just appear as a bit sequence with no particular meaning. An information format may specify different information types, e.g. by defining different types of information elements, and how these information types are structured, such as the order they occur in and/or their size, and particular meanings, typically predetermined and/or predefined, associated with the information types, respectively.

This action may fully or partly correspond to actions 72-74, 79-81 above.

Action 803

The wireless communication device 120 interprets information contained in the first part based on the identified information format.

This action may fully or partly correspond to actions 75, 77, 83 above.

Action 804a

If said first information format is identified, the wireless communication device 120 uses the interpreted information to send a request, to the wireless communication network 100, requesting said second part of SI.

This action may fully or partly correspond to action 76 above.

Action 805a

The wireless communication device 120 receives, from the wireless communication network 100 in response to the request sent in Action 804a, said second part of SI.

This action may fully or partly correspond to action 78 above.

Action 805b

If said second information format is identified, the wireless communication device 120 uses the interpreted information to receive said second part of SI, which second part in this case typically is periodically broadcasted.

This action may fully or partly correspond to action 84 above.

Action 806

The wireless communication device 120 may then access the wireless communication network 100 based on the received second part of SI.

This action may fully or partly correspond to action 85 above.

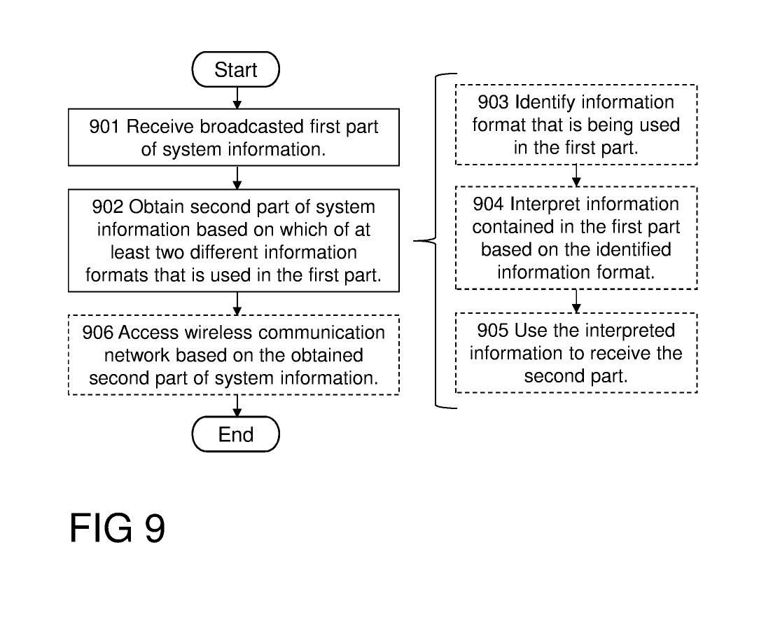

FIG. 9 is a flow chart schematically illustrating embodiments of a method, performed by a wireless communication device, e.g. the wireless communication device 120, for managing system information provided by a wireless communication network, e.g. the wireless communication network 100, that the wireless communication device 120 is configured to operate with. The method comprises the following actions, which actions may be taken in any suitable order and/or be carried out fully or partly overlapping in time when this is possible and suitable.

Action 901

The wireless communication device 120 receives a broadcasted first part of system information from the wireless communication network 100.

This action may fully or partly correspond to action 901 as described above.

Action 902

The wireless communication device 120 obtains a further, second part of system information based on which of at least two different information formats that is used in the first part.

A first information format of said at least two different information formats may be a format provided to contain information that enables the wireless communication device 120 to request, and in response to the request receive, said second part.

A second information format of said at least two different information formats may be a format provided to contain information that specify where the wireless communication device 120 can receive said second part.

The second part may be obtained based on which of said at least two different information formats that is comprised in predetermined bits in the broadcasted first part.

This action may fully or partly correspond to actions 802-805 as described above.

Action 903

In some embodiments, Action 901 comprises that the wireless communication device 120 identifies which of said at least two different information formats that is being used in the first part.

This action may fully or partly correspond to action 802 as described above.

Action 904

In some embodiments, Action 901 comprises that the wireless communication device 120 interprets information contained in the first part based on the identified information format from Action 903.

This action may fully or partly correspond to action 803 as described above.

Action 905

In some embodiments, Action 901 comprises that the wireless communication device 120 uses the interpreted information to:

if a first information format is identified, request, and in response to the request, receive said second part; and/or

if a second format is identified, receive the second part.

This action may fully or partly correspond to actions 804a-805a and/or action 805b as described above.

Action 906

The wireless communication device 120 may then access the wireless communication network 100 based on the received second part of system information.

This action may fully or partly correspond to action 806 as described above.

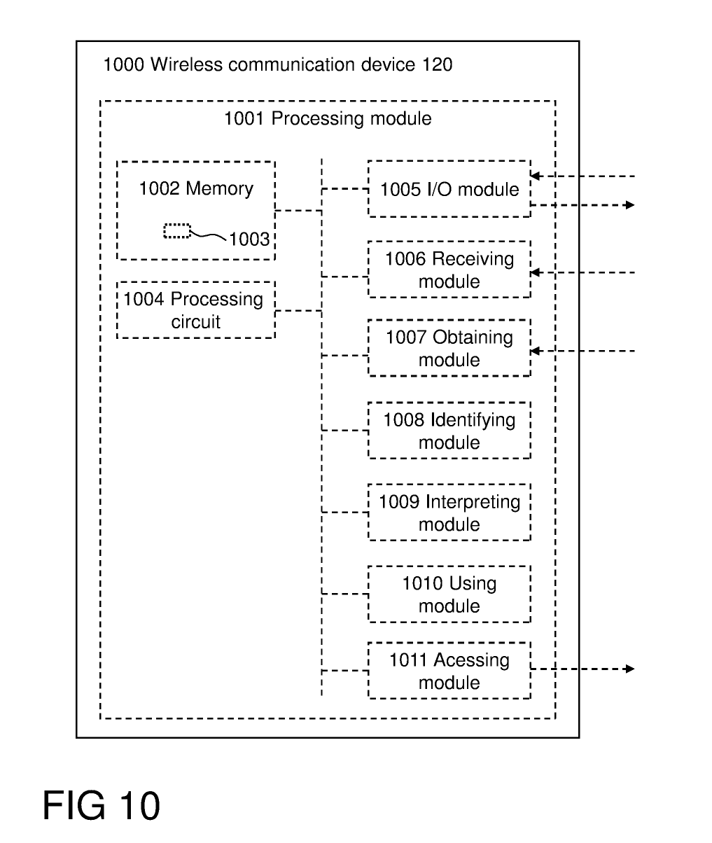

FIG. 10 is a schematic block diagram for illustrating embodiments of how the wireless communication device 120 may be configured to perform the method and actions discussed above in connection with FIG. 9.

Hence, the wireless communication device 120 is for managing system information provided by the wireless communication network 100 that the wireless communication device 120 is configured to operate with.

Hence, the wireless communication device 120 may comprise:

A processing module 1001, such as a means, one or more hardware modules, including e.g. one or more processors, and/or one or more software modules for performing said methods and/or actions.

A memory 1002, which may comprise, such as contain or store, a computer program 1003. The computer program 1003 comprises ‘instructions’ or ‘code’ directly or indirectly executable by the wireless communication device 120 so that it performs said method and/or actions. The memory 1002 may comprise one or more memory units and may be further be arranged to store data, such as configurations and/or applications involved in or for performing functions and actions of embodiments herein.

A processing circuit 1004, as an exemplifying hardware module and may comprise or correspond to one or more processors. In some embodiments, the processing module 1001 may comprise, e.g. ‘is embodied in the form of’ or ‘realized by’ the processing circuit 1004. In these embodiments, the memory 1002 may comprise the computer program 1003 executable by the processing circuit 1004, whereby the wireless communication device 120 comprising it is operative, or configured, to perform said method and/or actions.

An Input/Output (I/O) module 1005, configured to be involved in, e.g. by performing, any communication to and/or from other units and/or nodes, such as sending and/or receiving information to and/or from the wireless communication network 100 and one or more nodes thereof. The I/O module 1005 may be exemplified by an obtaining, e.g. receiving, module and/or a sending module, when applicable.

The wireless communication device 120 may also comprise other exemplifying hardware and/or software module(s), which module(s) may be fully or partly implemented by the processing circuit 1004. For example, the wireless communication device 120 may further comprise a receiving module 1006 and/or an obtaining module 1007 and/or an identifying module 1008 and/or an interpreting module 1009 and/or a using module 1010 and/or an accessing module 1011.

Hence, the wireless communication device 120 and/or the processing module 1001 and/or the processing circuit 1004 and/or the I/O module 1005 and/or the receiving module 1006, are operative, or configured, to receive said broadcasted first part of system information from the wireless communication network 100.

Further, the wireless communication device 120 and/or the processing module 1001 and/or the processing circuit 1004 and/or the I/O module 1005 and/or the obtaining module 1007, are operative, or configured, to obtain said further, second part of system information based on which of said at least two different information formats that is used in the first part.

In some embodiments, the wireless communication device 120 and/or the processing module 1001 and/or the processing circuit 1004 and/or the identifying module 1008, are operative, or configured, to identify which of said at least two different information formats that is being used in the first part.

Moreover, in some embodiments, the wireless communication device 120 and/or the processing module 1001 and/or the processing circuit 1004 and/or the interpreting module 1009, are operative, or configured, to interpret information contained in the first part based on the identified information format.

Furthermore, in some embodiments, the wireless communication device 120 and/or the processing module 1001 and/or the processing circuit 1004 and/or the using module 1010, are operative, or configured, to use the interpreted information to, if a first information format is identified, request, and in response to the request, receive said second part; and to use the interpreted information to, if a second format is identified, receive the second part.

Additionally, in some embodiments, the wireless communication device 120 and/or the processing module 1001 and/or the processing circuit 1004 and/or the accessing module 1011, are operative, or configured, to access the wireless communication network 100 based on the received second part of system information.

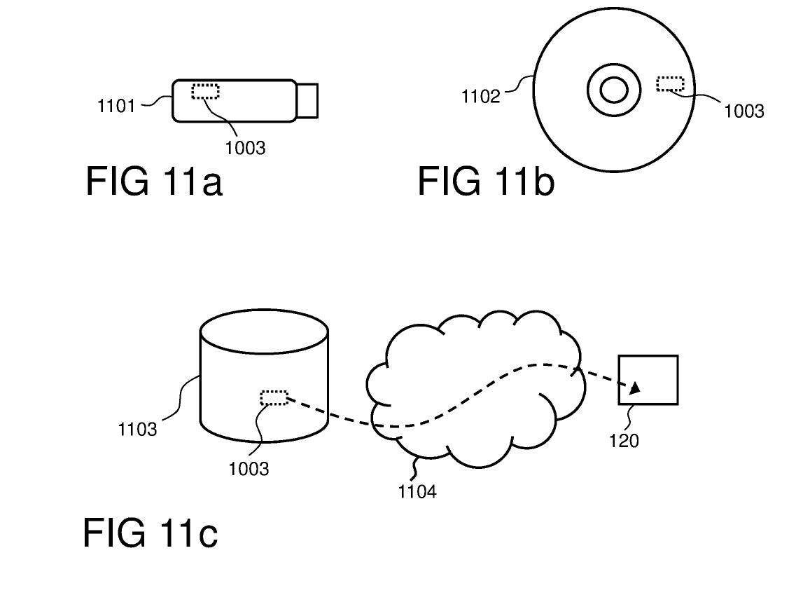

FIGS. 11a-c are schematic drawings illustrating embodiments relating to the computer program 1003 and that comprises instructions that when executed by the processing circuit 1004 and/or the processing module 1001, causes the wireless communication device 120 to perform as described above.

In some embodiments there is provided a carrier, such as a data carrier, e.g. a computer program product, comprising the computer program 1003. The carrier may be one of an electronic signal, an optical signal, a radio signal, and a computer readable medium. The computer program 1003 may thus be stored on the computer readable medium. By carrier may be excluded a transitory, propagating signal and the carrier may correspondingly be named non-transitory carrier. Non-limiting examples of the carrier being a computer-readable medium is a memory card or a memory stick 1101 as in FIG. 11 a, a disc storage medium 1102 such as a CD or DVD as in FIG. 11b, a mass storage device 1103 as in FIG. 11c. The mass storage device 1103 is typically based on hard drive(s) or Solid State Drive(s) (SSD). The mass storage device 1103 may be such that is used for storing data accessible over a computer network 1104, e.g. the Internet or a Local Area Network (LAN).

The computer program 1003 may furthermore be provided as a pure computer program or comprised in a file or files. The file or files may be stored on the computer-readable medium and e.g. available through download e.g. over the computer network 1104, such as from the mass storage device 1103 via a server. The server may e.g. be a web or File Transfer Protocol (FTP) server. The file or files may e.g. be executable files for direct or indirect download to and execution on the wireless communication device 120 for carrying out the method and/or actions as described above, e.g. by the processing circuit 1004. The file or files may also or alternatively be for intermediate download and compilation to make them executable before further download and/or execution causing the wireless communication device 120 to perform as described above.

Note that any processing module(s) mentioned in the foregoing may be implemented as a software and/or hardware module, e.g. in existing hardware and/or as an Application Specific integrated Circuit (ASIC), a field-programmable gate array (FPGA) or the like. Also note that any hardware module(s) and/or circuit(s) mentioned in the foregoing may e.g. be included in a single ASIC or FPGA, or be distributed among several separate hardware components, whether individually packaged or assembled into a System-on-a-Chip (SoC).

Those skilled in the art will also appreciate that the modules and circuitry discussed herein may refer to a combination of hardware modules, software modules, analogue and digital circuits, and/or one or more processors configured with software and/or firmware, e.g. stored in memory, that, when executed by the one or more processors make the wireless communication device 120 to be configured to and/or to perform the above-described method and/or actions.

Identification, e.g. by any identifier, herein may be implicit or explicit. The identification may be unique in the wireless communication network 100 or at least in a meaningful and relevant part or area thereof, as realized by the skilled person.

As used herein, the term “memory” may refer to a hard disk, a magnetic storage medium, a portable computer diskette or disc, flash memory, random access memory (RAM) or the like. Furthermore, the memory may be an internal register memory of a processor.

Also note that any enumerating terminology such as first node, second node, etc., that may have been used herein, as such should be considering non-limiting and the terminology as such does not imply a certain hierarchical relation. Without any explicit information in the contrary, naming by enumeration should be considered merely a way of accomplishing different names.

The term “network node” as used herein may as such in principle refer to any type of radio network node (described below) or any network node, which may communicate with at least a radio network node. Examples of such network nodes include any radio network node stated above, a core network node, an Operations & Maintenance (O&M) node, an Operations Support Systems (OSS) node, an Operation, Administration and Maintenance (OAM) node, a Self Organizing Network (SON) node, a positioning node etc. The term “radio network node” as used herein may as such refer to a network node comprised in a RAN, and is typically of a certain RAT, or any type of network node serving a wireless device, e.g. UE, and/or that are connected to and operating with other network node(s) or network element(s) or any radio node in order to send and/or receive radio signals to/from a communication device. Examples of radio network nodes are Node B, Base Station (BS), Multi-Standard Radio (MSR) node such as MSR BS, eNB, eNodeB, gNB, network controller, RNC, Base Station Controller (BSC), relay, donor node controlling relay, Base Transceiver Station (BTS), Access Point (AP), transmission points, transmission nodes, nodes in distributed antenna system (DAS) etc.

The term “ communication device” or “wireless communication device” as used herein, may as such refer to any type of communication device arranged to communicate with a radio network node in a wireless, communication network, such as the wireless communication network 100. Examples may include so called: device to device UE, device for Machine Type of Communication (MTC), MTC device, machine type UE or UE capable of machine to machine (M2M) communication, Personal Digital Assistant (PDA), iPAD, Tablet, mobile terminals, smart phone, Laptop Embedded Equipment (LEE), Laptop Mounted Equipment (LME), Universal Serial Bus (USB) dongles etc, just to mention some examples. While said terms are used frequently herein for convenience, or in the context of examples involving other 3GPP nomenclature, it must be appreciated that the term as such is non-limiting and the teachings herein apply to essentially any type of wireless communication device.

Note that although terminology used herein may be particularly associated with and/or exemplified by certain cellular communication systems, wireless communication networks etc., depending on terminology used, such as wireless communication networks based on 3GPP, this should as such not be seen as limiting the scope of the embodiments herein to only such certain systems, networks etc.

As used herein, the terms “number”, “value” may be any kind of digit, such as binary, real, imaginary or rational number or the like. Moreover, “number”, “value” may be one or more characters, such as a letter or a string of letters. Also, “number”, “value” may be represented by a bit string.

As used herein, the expression “in some embodiments” has been used to indicate that the features of the embodiment described may be combined with any other embodiment disclosed herein.

As used herein, the expression “transmit” and “send” are typically interchangeable. These expressions may include transmission by broadcasting, uni-casting, group-casting and the like. In this context, a transmission by broadcasting may be received and decoded by any authorized device within range. In case of uni-casting, one specifically addressed device may receive and encode the transmission. In case of group-casting, e.g. multi-casting, a group of specifically addressed devices may receive and decode the transmission.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the present disclosure, which is defined by the appending claims.

1-14. (canceled)

15. A method, performed by a wireless communication device, for managing system information provided by a wireless communication network that the wireless communication device is configured to operate with, wherein the method comprises:
receiving a broadcasted first part of system information from the wireless communication network; and
obtaining a further, second part of system information based on which of at least two different information formats is used in the first part.

16. The method as claimed in claim 15, wherein a first information format of said at least two different information formats is a format provided to contain information that enables the wireless communication device to request said second part and, in response to the request, receive said second part.

17. The method as claimed in claim 15, wherein a second information format of said at least two different information formats is a format provided to contain information that specifies where the wireless communication device can receive said second part.

18. The method as claimed in claim 15, wherein obtaining the second part comprises:
identifying which of said at least two different information formats is being used in the first part; and
interpreting information contained in the first part based on the identified information format.

19. The method as claimed in claim 18, wherein obtaining the second part further comprises:
using the interpreted information to,
if a first information format is identified, request, and in response to the request, receive said second part; and to,
if a second format is identified, receive the second part.

20. The method as claimed in claim 15, wherein the method further comprises:
accessing the wireless communication network based on the received second part of system information.

21. A non-transitory computer readable medium storing a computer program for managing system information provided by a wireless communication network that a wireless communication device is configured to operate with, the computer program comprising instructions that when executed by processing circuitry of the wireless communication device cause the wireless communication device to:
receive a broadcasted first part of system information from the wireless communication network; and
obtain a further, second part of system information based on which of at least two different information formats is used in the first part.

22. A wireless communication device configured for managing system information provided by a wireless communication network that the wireless communication device is configured to operate with, wherein the wireless communication device comprises:
communication circuitry configured for wirelessly communicating with the wireless communication network; and
processing circuitry operatively associated with the communication circuitry and configured to:
receive a broadcasted first part of system information from the wireless communication network; and
obtain a further, second part of system information based on which of at least two different information formats is used in the first part.

23. The wireless communication device as claimed in claim 22, wherein a first information format of said at least two different information formats is a format provided to contain information that enables the wireless communication device to request said second part and, in response to the request, receive said second part.

24. The wireless communication device as claimed in claim 22, wherein a second information format of said at least two different information formats is a format provided to contain information that specifies where the wireless communication device can receive said second part.

25. The wireless communication device as claimed in claim 22, wherein the processing circuitry is configured to:
identify which of said at least two different information formats is being used in the first part; and
interpret information contained in the first part based on the identified information format.

26. The wireless communication device as claimed in claim 25, wherein the processing circuitry is configured to:
use the interpreted information to,
if a first information format is identified, request, and in response to the request, receive said second part; and to,
if a second format is identified, receive the second part.

27. The wireless communication device as claimed in claim 22, wherein the processing circuitry is configured to:
access the wireless communication network based on the received second part of system information.
